(19) United States
(12) Patent Application Publication
(10) Pub. No.: US 2023/0056637 A1
(43) Pub. Date: Feb. 23, 2023

(54) HARDWARE AND SOFTWARE CONFIGURATION MANAGEMENT AND DEPLOYMENT

(71) Applicant: KYNDRYL, INC., NEW YORK, NY (US)

(72) Inventors: Joseph Reyes, Pelham, NY (US); Andrew S. Kronstadt, Pensacola, FL (US); Rennad Murugan, Sugar Land, TX (US); Marci Devorah Formato, Clintondale, NY (US); Jennifer L. Szkatulski, Detroit, MI (US); Bernhard Julius Klingenberg, Grover Beach, CA (US)

(21) Appl. No.: 17/445,338

(22) Filed: Aug. 18, 2021

(51) Int. Cl. G06F 11/34; G06N 3/04; G06F 9/50

(52) U.S. Cl. CPC G06F 11/3442; G06F 9/505; G06F 9/5055; G06N 3/0454

(57) ABSTRACT

A system, method, and computer program product for implementing configuration solution service management is provided. The method includes ingesting from managed hardware and software service components associated with a first entity, data and associated metadata associated with establishing baseline analysis code. The data and associated metadata are analyzed via execution of code associated with a recurrent neural network and long short-term memory configured to determine if a current managed hardware or software solution service design is associated with client requirements and industry trends. Recommendations, statistical analysis, predictions, a proposed new client profile, and sizing attributes of the additional managed hardware and software service components are generated. In response, additional managed hardware and software service components are configured with respect to operationally functionality for the first entity.

### BACKGROUND

The present invention relates generally to a system and method for managing hardware and software configuration solutions for service providers and in particular to a method and associated system for improving hardware and software technology associated with ingesting and analyzing data associated with hardware and software service components; and configuring additional managed hardware and software service components with respect to operationally functionality.

### SUMMARY

A first aspect of the invention provides a hardware device comprising a processor coupled to a computer-readable memory unit, the memory unit comprising instructions that when executed by the processor implements a configuration solution service management method comprising: ingesting, by the processor from managed hardware and software service components associated with a first entity, data and associated metadata associated with establishing baseline analysis code; analyzing, by the processor, the data and associated metadata via execution of code associated with a recurrent neural network (RNN) and long short term memory (LSTM) configured to determine if a current managed hardware or software solution service design is associated with client requirements and industry trends; first generating, by the processor based on results of the analyzing, recommendations, statistical analysis, and predictions associated with implemented managed solution services with respect to the managed hardware and software service components; second generating, by the processor, a proposed new client profile configured to predict future managed solution service offerings associated with additional managed hardware and software service components for the first entity, a sizing of the additional managed hardware and software service components, and current trends within an industry and geography associated with the first entity; and configuring, by the processor based on the proposed new client profile, the additional managed hardware and software service components with respect to operationally functionality for the first entity.

A second aspect of the invention provides a configuration solution service management method comprising: ingesting, by a processor of a hardware device from managed hardware and software service components associated with a first entity, data and associated metadata associated with establishing baseline analysis code; analyzing, by the processor, the data and associated metadata via execution of code associated with a recurrent neural network (RNN) and long short term memory (LSTM) configured to determine if a current managed hardware or software solution service design is associated with client requirements and industry trends; first generating, by the processor based on results of the analyzing, recommendations, statistical analysis, and predictions associated with implemented managed solution services with respect to the managed hardware and software service components; second generating, by the processor, a proposed new client profile configured to predict future managed solution service offerings associated with additional managed hardware and software service components for the first entity, a sizing of the additional managed hardware and software service components, and current trends within an industry and geography associated with the first entity; and configuring, by the processor based on the proposed new client profile, the additional managed hardware and software service components with respect to operationally functionality for the first entity.

A third aspect of the invention provides A computer program product, comprising a computer readable hardware storage device storing a computer readable program code, the computer readable program code comprising an algorithm that when executed by a processor of a hardware device implements a configuration solution service management method, the method comprising: ingesting, by the processor from managed hardware and software service components associated with a first entity, data and associated metadata associated with establishing baseline analysis code; analyzing, by the processor, the data and associated metadata via execution of code associated with a recurrent neural network (RNN) and long short term memory (LSTM) configured to determine if a current managed hardware or software solution service design is associated with client requirements and industry trends; first generating, by the processor based on results of the analyzing, recommendations, statistical analysis, and predictions associated with implemented managed solution services with respect to the managed hardware and software service components; second generating, by the processor, a proposed new client profile configured to predict future managed solution service offerings associated with additional managed hardware and software service components for the first entity, a sizing of the additional managed hardware and software service components, and current trends within an industry and geography associated with the first entity; and configuring, by the processor based on the proposed new client profile, the additional managed hardware and software service components with respect to operationally functionality for the first entity.

The present invention advantageously provides a simple method and associated system capable of managing hardware and software configuration solution services.

### BRIEF DESCRIPTION OF THE DRAWINGS

FIG. 1 illustrates a system for improving hardware and software technology associated with ingesting and analyzing data associated with hardware and software service components; and configuring additional managed hardware and software service components with respect to operationally functionality, in accordance with embodiments of the present invention.

FIG. 2 illustrates an algorithm detailing a process flow enabled by the system of FIG. 1 for improving hardware and software technology associated with ingesting and analyzing data associated with hardware and software service components; and configuring additional managed hardware and software service components with respect to operationally functionality, in accordance with embodiments of the present invention.

FIG. 3 illustrates an internal structural view of the software/hardware of FIG. 1, in accordance with embodiments of the present invention.

FIGS. 4A and 4B, in combination, illustrate a managed service meta database and analytics system enabled by the system of FIG. 1, in accordance with embodiments of the present invention.

FIG. 5 illustrates a computer system used by the system of FIG. 1 for improving hardware and software technology associated with ingesting and analyzing data associated with hardware and software service components; and configuring additional managed hardware and software service components with respect to operationally functionality, in accordance with embodiments of the present invention.

FIG. 6 illustrates a cloud computing environment, in accordance with embodiments of the present invention.

FIG. 7 illustrates a set of functional abstraction layers provided by cloud computing environment, in accordance with embodiments of the present invention.

### DETAILED DESCRIPTION

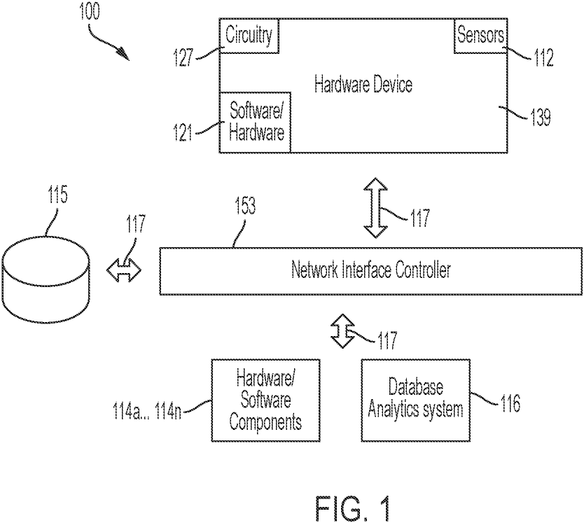

FIG. 1 illustrates a system 100 for improving hardware and software technology associated with ingesting and analyzing data associated with hardware and software service components; and configuring additional managed hardware and software service components with respect to operationally functionality, in accordance with embodiments of the present invention. Configuration management processes associated with hardware and software typically require managed services technology solution configurations determined based on client local environmental variables, change rates, and future growth. Multiple service bundled solutions may be generated thereby creating dependencies and interdependencies with respect to various milestones for successful implementation. For example, a client may execute a contract for a managed data center migration, disaster recovery data replication and/or cloud resiliency software produced in combination for a single client. Therefore, there may exist an expectation that each managed services technology solution must be sized accordingly since successful implementation dependencies exist amongst each other. Likewise, solution architects often may not accurately gather or understand true client environment variables such as steady state data change rate, and future growth metrics. Additionally, custom scripts or tools may be run with respect to client environments to capture operating system (OS), data, and backup server information. Typical custom scripts or tools may be isolated to client specific environments thereby reducing the ability to consider global industry shifts, technology trends, and/or future growth trends due to client demands. For example (with respect to backup as a solution service, architect implemented estimate associated with storage capacity pools to host applications, disaster recovery backup/replication data, and capacity for future workloads), if backup resources, computing resources, and storage resources are not sized properly, over time all backups may fail due to resource constraints thereby leading to a critical risk exposure for the client. Therefore, system 100 is configured to analyze pricing, scoping, and sizing capability of hardware and software systems/services thereby improving an accuracy of hardware and software system/service capability predictions with respect to client industry data trends and dynamic reductions of a number of hardware/software reconfigurations via analysis of a framework and feature mapping function. Likewise, system 100 is configured to optimize and apply operational functionality with respect to multiple industry client environments.

System 100 enables a process for collecting, mining, analyzing, obtaining trending data analysis, and providing data models and associated code by industry for creating accurate solution service predictions and associated hardware and software sizing. Likewise, system 100 enables a global telecommunication system (GTS) centralized managed service database for retrieving technical data, client geography data, industry data, environmental sizing data, growth trend data (with respect to a datacenter and/or emerging distributed data platforms), infrastructure data, middleware data, and application data fully managed as a solution service. Data gathering software tools may be enabled to gather metadata from managed solution service (hardware and software) components and/or individual entities to analyze metrics and analyze data for predicting accurate service architectural solutioning for single or bundled solution services, such as storage as a service (STaaS), backup as a service (BaaS), and disaster recovery as a service (DRaaS).

Data sources used to collect metadata may include a client configuration management database (CMDB) system such as a change control system for gathering historical, trend. and change rates with respect to specific hardware/software environments. Subsequently, managed service DB data is used to obtain metrics to validate and accurately predict client specific solution hardware and software architectures. Therefore, data analysis may be implemented during an architecting phase or to correctly size solutions accurately.

System 100 is configured to improve overengineering and/or under engineering technical solutions with respect to associated hardware and software. Under engineered solutions may result in retrofitting running environments which may cause system outages, loss of data, and service interruptions. Therefore, system 100 enables accurate and precise solutions associated with correct client growth trends for running environments optimally.

System 100 of FIG. 1 includes hardware device 139, hardware/software components 114a... 114n, a database analytics system 116, a database 115, and a network interface controller 153 interconnected through a network 7. Hardware device 139 comprises sensors 112, circuitry 127, and software/hardware 121. Hardware/software components 114a... 114n comprise components that include any type of hardware and software for operation with respect to any type of industrial operational solutions. For example, hardware/software components 114a... 114n may comprises computing/server systems, memory/database systems, CPU components, robotic devices, etc. Database analytics system 116 may comprise a system for analyzing data and associated metadata for associating a client system with industry and geography specific trending analysis data and code. Hardware device 139, hardware/software components 114a... 114n, and database analytics system 116 each may comprise an embedded device(s). An embedded device is defined herein as a dedicated device or computer comprising a combination of computer hardware and software (fixed in capability or programmable) specifically designed for executing a specialized function. Programmable embedded computers or devices may comprise specialized programming interfaces. In one embodiment, hardware device 139, hardware/software components 114a... 114n, and database analytics system 116 may each comprise a specialized hardware device comprising specialized (non-generic) hardware and circuitry (i.e., specialized discrete non-generic analog, digital, and logic-based circuitry) for (independently or in combination) executing a process described with respect to FIGS. 1-7. The specialized discrete non-generic analog, digital, and logic-based circuitry (e.g., sensors 112, circuitry 127, software/hardware 121, etc.) may include proprietary specially designed components (e.g., a specialized integrated circuit, such as for example an Application Specific Integrated Circuit (ASIC) designed for only implementing an automated process for improving hardware and software technology associated with ingesting and analyzing data associated with hardware and software service components; and configuring additional managed hardware and software service components with respect to operationally functionality. Sensors 112 may include any type of internal or external sensors including, inter alia, GPS sensors, Bluetooth beaconing sensors, cellular telephone detection sensors, Wi-Fi positioning detection sensors, triangulation detection sensors, activity tracking sensors, a temperature sensor, an ultrasonic sensor, an optical sensor, a video retrieval device, humidity sensors, voltage sensors, network traffic sensors, etc. Network 7 may include any type of network including, inter alia, a local area network, (LAN), a wide area network (WAN), the Internet, a wireless network, etc.

System 100 enables the following baseline analysis functionality with respect to configuring managed hardware and software solution services associated with operational functionality:

Relevant data and metadata associated with establishing a hardware and software service component baseline is ingested such that (during an initial deal sales contract) data and metadata associated with a client, a cost case, and deal information is ingested. For example, the data and metadata may be associated with a company, an industry, a geography, a legacy or greenfield, tower device counts (storage footprints, computing footprints, server counts, client device counts, network device counts, etc.), corporate data, yearly sales, level of integration (verticals), analysts assigned storage manager (SM), subject matter expert (SME), computer science and engineering (CSE), etc.). Likewise, the data and metadata may be associated with parameters associated with selection of relevant data for analysis with respect to existing practice parameters via execution of natural language processing (NLP) text analysis to extract tagged data with respect to relevant ingestion attributes. The tagged data is weighted and scored based on an SME evaluation with respect to quality status. Additionally, previously retrieved metadata current sizing tool parameters, and contract information is analyzed via learning module code and an initial hardware/software operation deal is generated. The initial hardware/software operation deal is compared with respect to insights gathered such that multi-client hardware/software environments are compared with respect to industry, infrastructure technologies, software applications, historical trending, and future forecasting for implementing industry leading solutions. When the initial hardware/software operation deal is executed, a solution architect runs executes gathering tools or custom scripts with respect to a client environment to gather data via sensors, agents, or data retrieval scripts (e.g., log extraction, SQL queries, system info, application commands, etc.). The scripts may be configured to run on a backup/restore server system for collecting data such as, inter alia, reporting info, internal system database (DB) queries with respect to data, operating system data, backup hardware/software product data, internal DB data, logs, etc. Additionally, when the initial hardware/software operation deal is executed: a system change rate is modified, a current hardware/software sizing is modified, a number and attributes of servers are modified, a growth rate is modified, changes over time are modified. Furthermore, the following functionality is enabled:
1. Statistical storage based on initial sizing requirements.
2. Usage statistic storage.
3. Intake of new server information.
4. Anticipated goals are generated.
5. Servers are enabled to access a number of machines for diverse clients.
6. Information is leveraged to create complex statistical models (and associated computer code) used for quality assurance.

System 100 enables the following system profile analysis and operational functionality with respect to a hardware/software system sizing:

The system profile analysis is initialized when a solution architect retrieves gathered data and feeds it into a managed service meta DB analytics system. Subsequently, a massive repository of meta data analysis results is configured to associate a client with industry and geography trending analysis data. Likewise, analysis systems (comprising a single point reference) are configured to track environmental variables for multiple clients with respect to, inter alia, a 6 month history, growth data, solution issues, a baseline for all client’s managed services, a baseline for comparable services (e.g., size, industry, geography)

System 100 enables the following system analysis and output functionality with respect to a hardware/software system operational functionality:

Long short term memory (RNN-LSTM) ingested data is analyzed and processed via execution of a data science recurrent neural network (RNN). The RNN analyzes time with respect to execution of a LSTM long term memory neural network algorithm. The RNN is configured to model a sequence of data such that each data sample may be dependent on previous data samples. Likewise, the LSTM is configured to classify, process, predict, and train a data model with respect to key metrics, a success growth/rate, and a capacity load resulting in a generated output comprising recommendations, a resize for accuracy growth, and a metadata and deal analysis, a statistical analysis, and predictions based on clients within a same industry, geography, and custom configuration. Subsequently, the RNN-LSTM calculates trends with respect to operation of an external cloud DB and a configuration management database and a new client profile is generated.

The following implementation example describes a key usage process associated retrieval of best practice security standards at backup/restore sever level.

The process is initiated when feedback data is provided to sellers for selecting hardware/software products and an associated portfolio. For example, feedback data may include trends, industry specific technology adoption rates and standards such as financial industry utilizing data in flight encryption, etc. Subsequently, hardware/software device reliability factors are retrieved (from associated meta data) and analyzed. For example, device reliability factors associated with tape libraries and meta data error codes may be retrieved from multiple libraries and analyzed for predicting imminent component failure-based code patterns. Associated hardware error code patterns and related meta data may be used to predict error code patterns leading up to failures and provide auto self-healing fault recovery using machine learning processes to perform development enhancements for hardware solutions. Likewise, statistics associated with failures, crash causes, and outage events may be analyzed for building reliable hardware trending data for use in understanding a competitive landscape. Software and service products may be compared with respect to industry and corporate sizes to determine reliability, performance, and industry trends. The aforementioned process results in retrieval of best practice security standards at multiple levels for managed service component/devices.

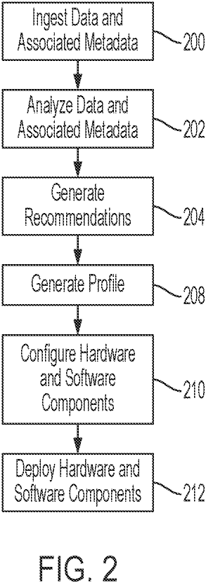

FIG. 2 illustrates an algorithm detailing a process flow enabled by system 100 of FIG. 1 for improving hardware and software technology associated with ingesting and analyzing data associated with hardware and software service components; and configuring additional managed hardware and software service components with respect to operationally functionality, in accordance with embodiments of the present invention. Each of the steps in the algorithm of FIG. 2 may be enabled and executed in any order by a computer processor(s) executing computer code. Additionally, each of the steps in the algorithm of FIG. 2 may be enabled and executed in combination by hardware device 139, hardware/software components 114a... 114n, and/or database analytics system. In step 200, data and associated metadata (associated with establishing baseline analysis code) is ingested from managed hardware and software service components associated with an entity. Establishing the baseline analysis code may include feeding the data and associated metadata into a centralized managed service database analytics system configured to associate a client system with industry and geography specific trending analysis data and code. The data and associated metadata may include, inter alia, industry related data, geographical related data, hardware and software related data, etc.

In step 202, the data and associated metadata is analyzed via execution of code associated with a recurrent neural network (RNN) and long short term memory (LSTM) configured to determine if a current managed hardware or software solution service design is associated with client requirements and industry trends. Associated RNN model sequences of the data and associated metadata are executed such that each sample of the data and associated metadata is determined to be dependent from previous samples associated with the data and associated metadata. The LSTM may be associated with previously generated data within a memory structure. Likewise, the LSTM may be configured to be executed to classify, process, predict, and train a model generated as a result of the analysis of step 202.

In step 204, recommendations, statistical analysis, and predictions are generated based on results of the analysis of step 202. The recommendations, statistical analysis, and predictions are associated with implemented managed solution services with respect to the managed hardware and software service components. Generating the recommendations, statistical analysis, and predictions may be executed based on: client requirements of the entity with respect to client requirements of additional entities within a same industry of the entity, geographical and custom configurations hardware and software service components of the additional entities, and industry trends associated with the additional entities and determined via execution of the code associated with the RNN and LSTM.

In step 208, a proposed new client profile is generated. The proposed new client profile is configured to predict future managed solution service offerings associated with additional managed hardware and software service components for the entity, a sizing of the additional managed hardware and software service components, and current trends within an industry and geography associated with the entity. In step 210, the additional managed hardware and software service components are configured with respect to operationally functionality for the entity. In step 212, the additional managed hardware and software service components are deployed with respect to a facility of the entity based on results of step 210.

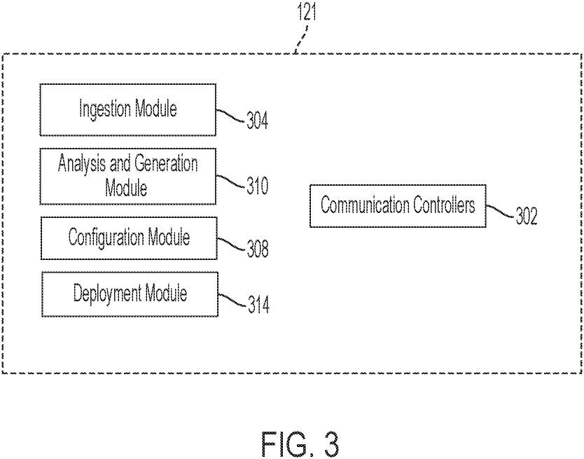

FIG. 3 illustrates an internal structural view of software/hardware 121 of FIG. 1, in accordance with embodiments of the present invention. Software/hardware 121 includes an ingestion module 304, an analysis and generation module 310, a configuration module 308, a deployment module 314, and communication controllers 302. Ingestion module 304 comprises specialized hardware and software for controlling all functions related to the ingestion/retrieval steps of FIG. 2. Analysis and generation module 310 comprises specialized hardware and software for controlling all functionality related to the Analysis and generation steps described with respect to the algorithm of FIG. 2. Configuration module 308 module 308 comprises specialized hardware and software for controlling all functions related to the hardware and software configuration steps of FIG. 2. Deployment module 314 comprises specialized hardware and software for controlling all functions related to the hardware and software deployment steps of the algorithm of FIG. 2. Communication controllers 302 are enabled for controlling all communications between ingestion module 304, analysis and generation module 310, configuration module 308, and deployment module 314.

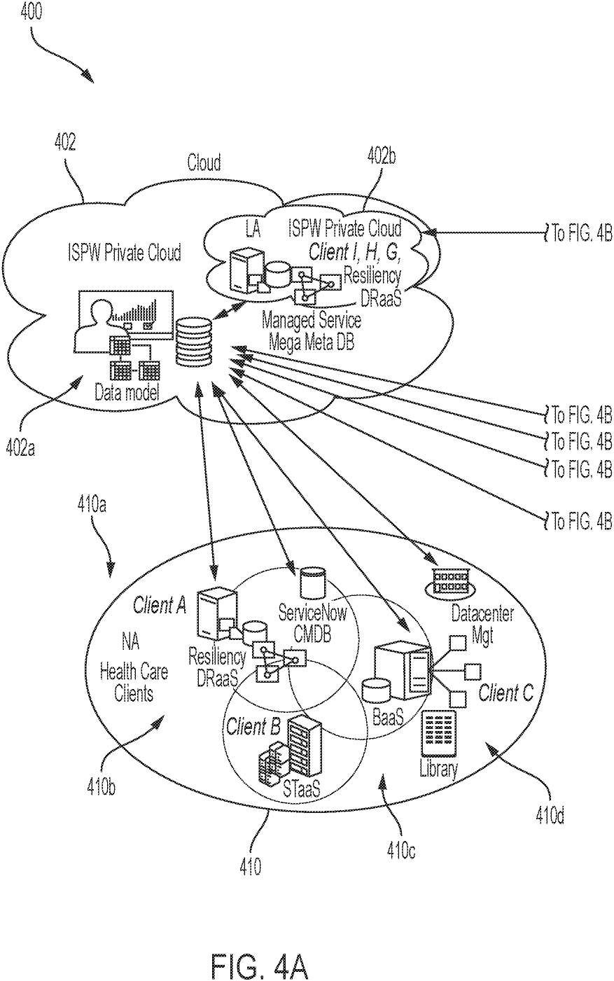

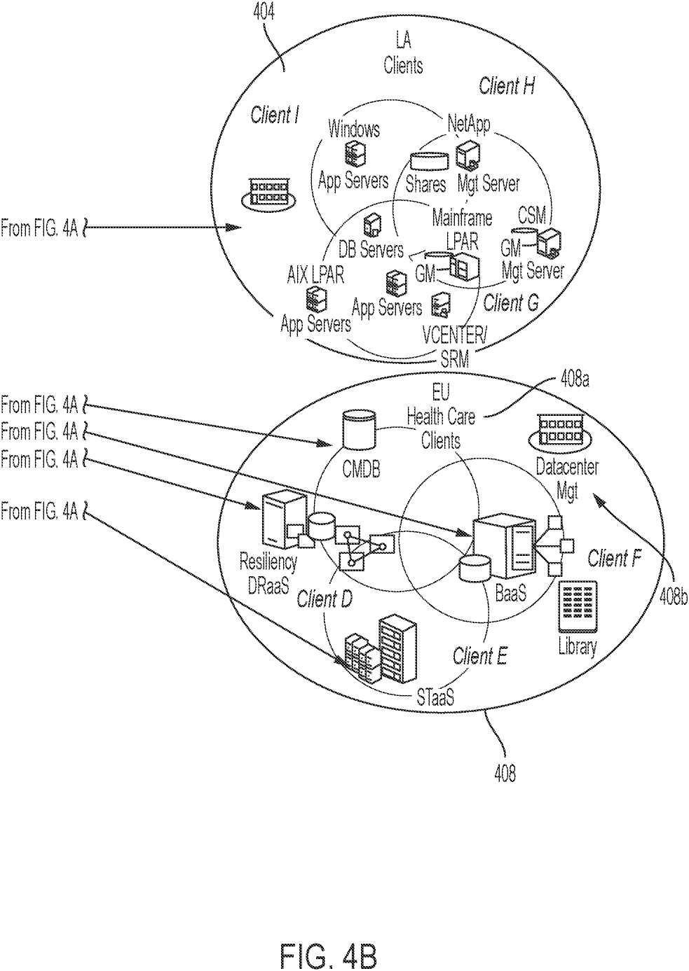

FIGS. 4A and 4B, in combination, illustrate a managed service meta database and analytics system 400 enabled by system 100 of FIG. 1, in accordance with embodiments of the present invention. Managed service meta database and analytics system 400 is configured to collect meta data from a backup as a service (BaaS) component, a storage as a service (StaaS) component, and a disaster recovery as a service (DRaaS) component with respect to client on premise and cloud solutions. Managed service meta database and analytics system 400 is an artificial intelligence (AI) system for accessing a client environment datacenter or cloud environment managed components. Managed service meta database and analytics system 400 comprises a cloud system 402 and data centers 404, 408, and 410 interconnected. Cloud system 402 is a public cloud system comprising a private cloud hosting a managed service AI system and DB 402a. Latin America (LA) client cloud environment 402b comprises a disaster recovery as a service (DRaaS) solution being run within cloud system 402. LA client cloud environment 402b feeds data into a managed services AI ingestion component. Data centers 404, 408, and 410 comprise differing physical datacenters within differing geographical regions such as Latin America (LA), Europe (EU), and North America (NA). Data centers 404, 408, and 410 comprise a variety of infrastructure, storage, platforms, servers, applications, and configurations illustrating client customization. Datacenter 408 comprises a non-cloud on-premise environment 408b illustrating data output retrieved from any location using client tools to feed data to a managed services ingestion system. Datacenter 410 comprises a backup as a service (BaaS) system 410d, a storage as a services (StaaS) system 410c, and a disaster recovery as a service (DRaaS) system 410b.

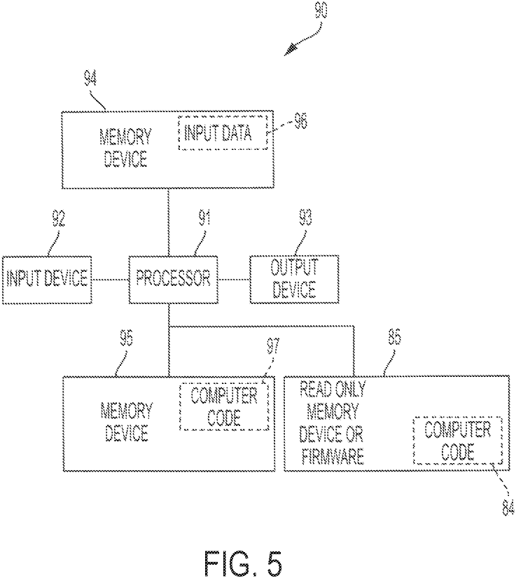

FIG. 5 illustrates a computer system 90 (e.g., hardware device 139 and hardware/software components 114a... 114n of FIG. 1) used by or comprised by the system 100 of FIG. 1 for improving hardware and software technology associated with ingesting and analyzing data associated with hardware and software service components; and configuring additional managed hardware and software service components with respect to operationally functionality, in accordance with embodiments of the present invention.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer system 90 illustrated in FIG. 5 includes a processor 91, an input device 92 coupled to the processor 91, an output device 93 coupled to the processor 91, and memory devices 94 and 95 each coupled to the processor 91. The input device 92 may be, inter alia, a keyboard, a mouse, a camera, a touchscreen, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for improving hardware and software technology associated with ingesting and analyzing data associated with hardware and software service components; and configuring additional managed hardware and software service components with respect to operationally functionality. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices Such as read only memory device 96) may include algorithms (e.g., the algorithm of FIG. 2) and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 84 (e.g., including algorithms) may be stored on a static, nonremovable, read-only storage medium such as a Read-Only Memory (ROM) device 85, or may be accessed by processor 91 directly from such a static, nonremovable, read-only medium. Similarly, in some embodiments, stored computer program code 97 may be stored as computer-readable firmware 85, or may be accessed by processor 91 directly from such firmware 85, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve hardware and software technology associated with ingesting and analyzing data associated with hardware and software service components; and configuring additional managed hardware and software service components with respect to operationally functionality. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving hardware and software technology associated with ingesting and analyzing data associated with hardware and software service components; and configuring additional managed hardware and software service components with respect to operationally functionality. In another embodiment, the invention provides a business method that performs the process steps of the invention on a subscription, advertising, and/or fee basis. That is, a service supplier, such as a Solution Integrator, could offer to enable a process for improving hardware and software technology associated with ingesting and analyzing data associated with hardware and software service components; and configuring additional managed hardware and software service components with respect to operationally functionality. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

### Cloud Computing Environment

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

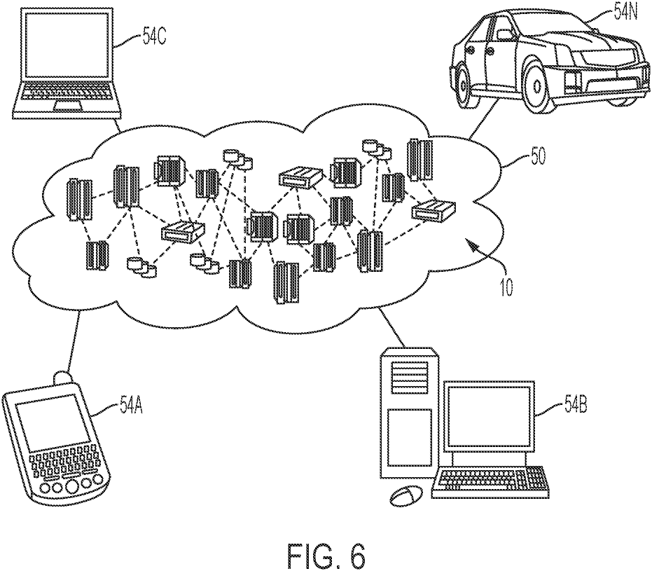

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 12 are intended to be illustrative only and that computing nodes 10 and cloud computing environment 50 can communicate with any type of computerized device over any type of network and/or network addressable connection (e.g., using a web browser).

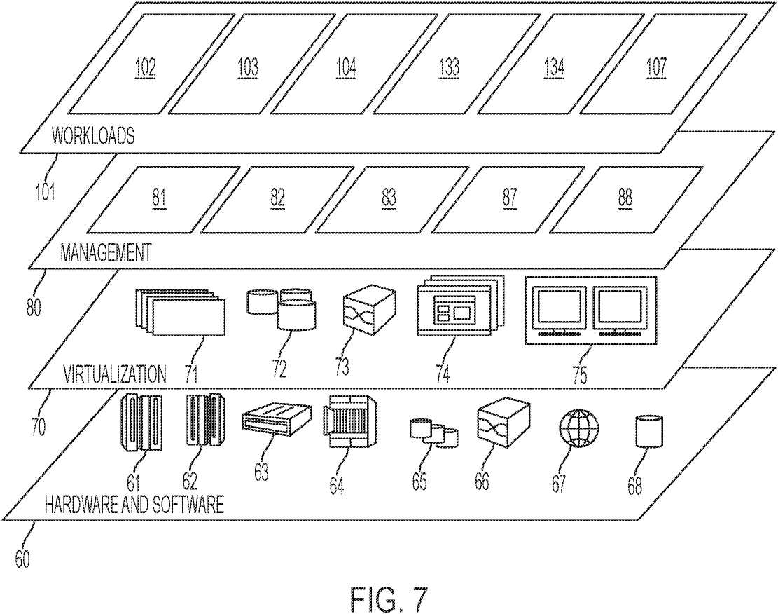

Referring now to FIG. 7, a set of functional abstraction layers provided by cloud computing environment 50 (see FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 87 provides cloud computing resource allocation and management such that required service levels are met. Service Level Agreement (SLA) planning and fulfillment 88 provide pre-arrangement for, and procurement of, cloud computing resources for which a future requirement is anticipated in accordance with an SLA.

Workloads layer 101 provides examples of functionality for which the cloud computing environment may be utilized. Examples of workloads and functions which may be provided from this layer include: mapping and navigation 102; software development and lifecycle management 103; virtual classroom education delivery 133; data analytics processing 134; transaction processing 106; and for improving video and software technology associated with extracting from a video stream and categorizing, skeleton points associated with a video representation of a user executing user movement actions; generating initial visual windows surrounding a group of skeleton points; extracting and linking feature vectors with point coordinates; and improving hardware and software technology associated with ingesting and analyzing data associated with hardware and software service components; and configuring additional managed hardware and software service components with respect to operationally functionality 107.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A hardware device comprising a processor coupled to a computer-readable memory unit, said memory unit comprising instructions that when executed by the processor implements a configuration solution service management method comprising:
ingesting, by said processor from managed hardware and software service components associated with a first entity, data and associated metadata associated with establishing baseline analysis code;
analyzing, by said processor, said data and associated metadata via execution of code associated with a recurrent neural network (RNN) and long short-term memory (LSTM) configured to determine if a current managed hardware or software solution service design is associated with client requirements and industry trends;
first generating, by said processor based on results of said analyzing, recommendations, statistical analysis, and predictions associated with implemented managed solution services with respect to said managed hardware and software service components;
second generating, by said processor, a proposed new client profile configured to predict future managed solution service offerings associated with additional managed hardware and software service components for said first entity, a sizing of said additional managed hardware and software service components, and current trends within an industry and geography associated with said first entity; and
configuring, by said processor based on said proposed new client profile, said additional managed hardware and software service components with respect to operationally functionality for said first entity.

2. The hardware device of claim 1, wherein said establishing said baseline analysis code comprises feeding said data and associated metadata into a centralized managed service database analytics system configured to associate a client system with industry and geography specific trending analysis data and code.

3. The hardware device of claim 1, wherein associated RNN model sequences of said data and associated metadata are executed such that each sample of said data and associated metadata is determined to be dependent from previous samples associated with said data and associated metadata.

4. The hardware device of claim 3, wherein said LSTM is associated with previously generated data within a memory structure.

5. The hardware device of claim 3, wherein said LSTM is configured to be executed to classify, process, predict, and train a model generated as a result of said analyzing.

6. The hardware device of claim 1, wherein said first generating is executed based on: client requirements of said entity with respect to client requirements of additional entities within the same industry of said entity, geographical and custom configurations hardware and software service components of said additional entities, and industry trends associated with said additional entities and determined via execution of said code associated with said RNN and said LSTM.

7. The hardware device of claim 1, wherein said method further comprises:
deploying, by said processor with respect to results of said configuring, said additional managed hardware and software service components with respect to a facility of said first entity.

8. The hardware device of claim 1, wherein said data and associated metadata comprise entity related data selected from the group consisting of industry related data, geographical related data, and hardware and software related data.

9. A configuration solution service management method comprising:
ingesting, by a processor of a hardware device from managed hardware and software service components associated with a first entity, data and associated metadata associated with establishing baseline analysis code;
analyzing, by said processor, said data and associated metadata via execution of code associated with a recurrent neural network (RNN) and long short-term memory (LSTM) configured to determine if a current managed hardware or software solution service design is associated with client requirements and industry trends;
first generating, by said processor based on results of said analyzing, recommendations, statistical analysis, and predictions associated with implemented managed solution services with respect to said managed hardware and software service components;
second generating, by said processor, a proposed new client profile configured to predict future managed solution service offerings associated with additional managed hardware and software service components for said first entity, a sizing of said additional managed hardware and software service components, and current trends within an industry and geography associated with said first entity; and
configuring, by said processor based on said proposed new client profile, said additional managed hardware and software service components with respect to operationally functionality for said first entity.

10. The method of claim 9, wherein said establishing said baseline analysis code comprises feeding said data and associated metadata into a centralized managed service database analytics system configured to associate a client system with industry and geography specific trending analysis data and code.

11. The method of claim 9, wherein associated RNN model sequences of said data and associated metadata are executed such that each sample of said data and associated metadata is determined to be dependent from previous samples associated with said data and associated metadata.

12. The method of claim 11, wherein said LSTM is associated with previously generated data within a memory structure.

13. The method of claim 11, wherein said LSTM is configured to be executed to classify, process, predict, and train a model generated as a result of said analyzing.

14. The method of claim 11, wherein said first generating is executed based on: client requirements of said entity with respect to client requirements of additional entities within the same industry of said entity, geographical and custom configurations hardware and software service components of said additional entities, and industry trends associated with said additional entities and determined via execution of said code associated with said RNN and said LSTM.

15. The method of claim 9, further comprising:
deploying, by said processor with respect to results of said configuring, said additional managed hardware and software service components with respect to a facility of said first entity.

16. The method of claim 9, wherein said data and associated metadata comprise entity related data selected from the group consisting of industry related data, geographical related data, and hardware and software related data.

17. The method of claim 9, further comprising:
providing at least one support service for at least one of creating, integrating, hosting, maintaining, and deploying computer-readable code in the hardware device, said code being executed by the processor to implement: said ingesting, said analyzing, said first generating, said second generating, and said configuring.

18. A computer program product, comprising a computer readable hardware storage device storing a computer readable program code, said computer readable program code comprising an algorithm that when executed by a processor of a hardware device implements a configuration solution service management method, said method comprising:
ingesting, by said processor from managed hardware and software service components associated with a first entity, data and associated metadata associated with establishing baseline analysis code;
analyzing, by said processor, said data and associated metadata via execution of code associated with a recurrent neural network (RNN) and long short-term memory (LSTM) configured to determine if a current managed hardware or software solution service design is associated with client requirements and industry trends;
first generating, by said processor based on results of said analyzing, recommendations, statistical analysis, and predictions associated with implemented managed solution services with respect to said managed hardware and software service components;
second generating, by said processor, a proposed new client profile configured to predict future managed solution service offerings associated with additional managed hardware and software service components for said first entity, a sizing of said additional managed hardware and software service components, and current trends within an industry and geography associated with said first entity; and
configuring, by said processor based on said proposed new client profile, said additional managed hardware and software service components with respect to operationally functionality for said first entity.

19. The computer program product of claim 18, wherein said establishing said baseline analysis code comprises feeding said data and associated metadata into a centralized managed service database analytics system configured to associate a client system with industry and geography specific trending analysis data and code.

20. The computer program product of claim 18, wherein associated RNN model sequences of said data and associated metadata are executed such that each sample of said data and associated metadata is determined to be dependent from previous samples associated with said data and associated metadata.
